(19) United States
(12) Patent Application Publication
(10) Pub. No.: US 2006/0222327 A1
(43) Pub. Date: Oct. 5, 2006

(54) Reserved program recording apparatus and its method

(75) Inventors: Kazuhiko Abe, Kanagawa (JP); Tatsuya Uehara, Tokyo (JP); Kohei Momosaki, Kanagawa (JP); Yasuyuki Masai, Kanagawa (JP); Munehiko Sasajima, Osaka (JP); Kazunori Imoto, Kanagawa (JP); Manabu Nagao, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/390,394

(22) Filed: Mar. 28, 2006

(30) Foreign Application Priority Data
Mar. 29, 2005 (JP) 2005-96537

(51) Int. Cl. H04N 5/91

(52) U.S. Cl. 386/83

(57) ABSTRACT

A broadcast reception apparatus 10 includes a broadcast program reception part 101 to acquire broadcast program information from a signal of a broadcast program, an audio information temporary storage part 103 to acquire audio information of the broadcast program to be recorded and to temporarily store it onto an audio information temporary recording medium 102, an audio check part 105 to check audio key information recorded on an audio key recording medium 104 against the temporarily stored audio information, a program reservation control part 106 to determine a program reservation control method based on an audio check result, and a broadcast program recording part 108 to record the reserved program onto a broadcast program recording medium 107.

### CROSS-REFERENCE TO RELATED APPLICATIONS

This application is based upon and claims the benefit of priority from the prior Japanese Patent Application No. 2005-96537, filed on Mar. 29, 2005; the entire contents of which are incorporated herein by reference.

### TECHNICAL FIELD

The present invention relates to a reserved program recording apparatus for performing picture recording or audio recording of a reserved program, and its method.

### BACKGROUND OF THE INVENTION

Although a viewer confirms broadcast content and broadcast time by the program table of a newspaper, magazine or the like, and can reserve recording after confirming the necessity of the recording. However, it has been difficult to change the reservation in accordance with a change in program content which is not reflected on the program table.

As in Japanese Kokai Patent 10-21601, although there is proposed a method in which with respect to a program with a possibility of extension, a reservation is made on the assumption that the extension occurs, there have been problems that an influence is needlessly exerted on the recording plan of another program, and unnecessary data remains on a recording medium.

Then, the present invention realizes a reserved program recording apparatus which can accurately record a program desired by a viewer.

### BRIEF SUMMARY OF THE INVENTION

According to embodiments of the present invention, a reserved program recording apparatus is for performing picture recording or audio recording of a broadcasted or delivered program, as a reserved program, onto a recording medium based on a previously set recording plan including a reservation start time or a reservation end time, and includes a program data acquisition processor unit to acquire program data of the broadcasted or delivered program, an audio data acquisition processor unit to acquire audio data of the broadcasted or delivered program, a key audio data acquisition processor unit to read key audio data used for confirmation of content of the broadcasted or delivered program from the recording medium, a key audio data check processor unit to check the key audio data against the audio data and to acquire check result information, and a program reservation change processor unit to change the recording plan based on the check result information.

In the invention, the content of the program is confirmed, so that it becomes possible to perform picture recording or audio recording of only the program required by the viewer, and the possibility of extension of the picture recording or the audio recording is judged and the recording plan can be changed.

### BRIEF DESCRIPTION OF THE DRAWINGS

FIG. 1 is a block diagram schematically showing a broadcast reception apparatus according to a first embodiment of the invention.

FIG. 2 is a flowchart showing a reservation control processing to a program being recorded according to the first embodiment of the invention.

FIG. 3 is a block diagram schematically showing a broadcast reception apparatus according to a second embodiment of the invention.

FIG. 4 is a block diagram schematically showing a broadcast reception apparatus according to a third embodiment of the invention.

FIG. 5 is a view showing a recording plan of a reserved program.

FIG. 6 is a view showing a recording plan of reserved programs when recording is performed for plural broadcast stations.

FIG. 7 is a flowchart showing an operation of estimating a delay time of a start of a reserved program being recorded and changing a recording end scheduled time by the delay time.

FIG. 8 is a view showing a first method in which an audio key check is performed against a reserved program and a program start delay time is estimated.

FIG. 9 is a flowchart showing an operation of estimating a delay time from a program broadcasted before a reserved program, changing a recording time, and recording another program for the delay estimated time.

FIG. 10 is a flowchart showing an operation of using a check result of key audio data, making a judgment of a recording end condition and ending the recording.

FIG. 11 is a view showing a use method, at a viewing time, of a key audio data check result to a recorded reserved program.

FIG. 12 is a view showing a method in which a key audio data check result to a reserved program is used, and recording content to an external medium is determined.

### DETAILED DESCRIPTION OF THE INVENTION

Hereinafter, embodiments of the invention will be specifically described with reference to the drawings.

### First Embodiment

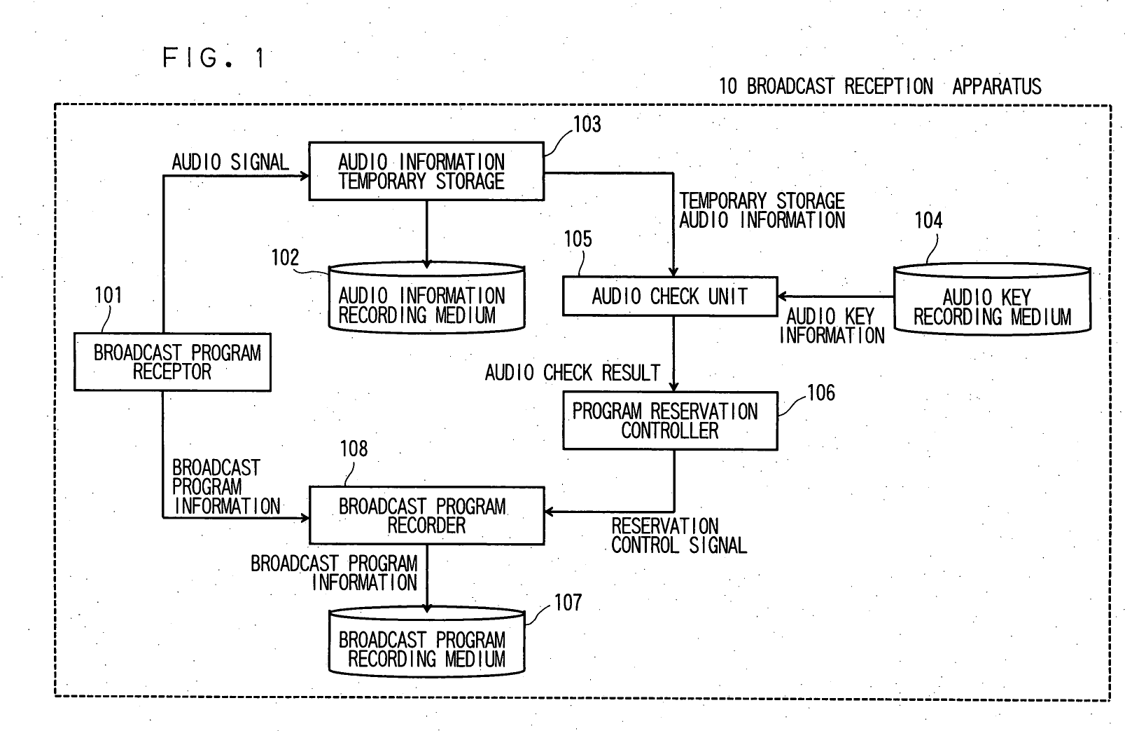

A broadcast reception apparatus 10 of a first embodiment in which a reserved program recording apparatus of the invention is applied will be described with reference to FIGS. 1, 2 and 5 to 12. This embodiment is carried out as a product such as, for example, a video recorder or a HDD recorder, to receive and record a television broadcast.

(1) Structure of the Broadcast Reception Apparatus 10

FIG. 1 is a block diagram showing the broadcast reception apparatus 10 of this embodiment.

As shown in FIG. 1, the broadcast reception apparatus 10 includes a broadcast program reception part 101 to acquire broadcast program information from a signal of a broadcast program, an audio information temporary storage part 103 to acquire audio information of the broadcast program to be recorded and to temporarily store it onto an audio information temporary recording medium 102, an audio check part 105 to check audio key information recorded on an audio key recording medium 104 against the temporarily stored audio information, a program reservation control part 106 to determine a program reservation control method based on an audio check result, and a broadcast program recording part 108 to record the broadcast program (hereinafter referred to as the reserved program) onto a broadcast program recording medium 107.

The broadcast program information acquired by the broadcast program reception part 101 may be a broadcast program of a reception channel selected by a tuner provided in the apparatus, or may be a broadcast program supplied from the outside through an input terminal.

The broadcast reception part 101 acquires the broadcast program information to be recorded from the acquired broadcast program signal, separates and acquires broadcast program audio data, and supplies it to the audio information temporary storage part 103.

The audio information temporary storage part 103 temporarily records the acquired broadcast program audio data onto the audio information temporary storage medium 102, and supplies it to the audio check part 105 based on an instruction from the audio check part 105. The audio information temporary storage medium 102 is constructed of, for example, an IC memory or the like.

The audio check part 105 acquires the broadcast program audio information in a certain section from the audio information temporary storage part 103, acquires the key audio data from the key audio data recording medium 104, and performs a check. The check is performed based on a previously determined specified condition, such as a method of detecting only completely the same things or detection of existence of places similar to each other in audio feature amount, and the check result is supplied to the program reservation control part 106.

The program reservation control part 106 refers to the audio check result, determines the reservation control method, and supplies a program reservation control signal to the broadcast recording part 108. For example, a delay or a change in broadcast time is predicted based on the result of the audio check against the audio data of a scene appearing at the identical time, and the control signal to change the reservation content is supplied to the broadcast program recording part 108.

The broadcast program recording part 108 acquires the broadcast program information based on a previously set recording plan, and records the reserved program onto the broadcast program recording medium 107. The broadcast program recording medium 107 is constructed of, for example, an optical disk, a HDD (magnetic disk), a magnetic tape or the like. The broadcast program recording part acquires the program reservation control signal, and can change the recording plan. The control of reservation includes an extension of reservation time, a stop of the reservation and the like.

(2) Examples of Reservation Control Method

Examples of key audio data to be checked and the corresponding reservation control method carried out in the broadcast reception apparatus 10 include the following.

(2-1) Method in which key audio data indicating the end of a reserved program is checked, and recording is continued until the key audio data is detected.

For example, when a drama starting at 9 p.m. is recorded, there is a case where since the drama is the final episode, it is extended by 30 minutes. In this case, when the recording time is extended until the theme music of the ending of the drama streams, the latter 30 minutes is not cut and the whole can be recorded.

(2-2) Method in which key audio data indicating the opening of a next program of a reserved program is checked, and recording is continued until the key audio data is detected.

For example, when a drama starting from 9 p.m. is recorded, there is a case where since the drama is the final episode, it is extended by 30 minutes. In this case, when the recording time is extended until the theme music of the opening of the news scheduled to be next broadcasted streams, the latter 30 minutes is not cut and the whole can be recorded.

(2-3) Method in which key audio data indicating the corner of a program produced at irregular intervals in the reserved program is checked, and when the key audio data is not detected throughout the program, the recording of the reserved program is deleted.

For example, in the case where a corner by a special guest is produced once a month in a variety program, when the theme music of the corner streams, the recording is left as it is, and when not stream, it is deleted.

(2-4) Method in which a check against key audio data, such as a shout of joy or music, by which the result or the upsurge of a sport as the reserved program can be judged, is performed, and when there is no certain similarity to the key audio data, the recording of the reserved program is ended.

For example, in a baseball relay, when a favorite team A plays a game in a home baseball ground, the shout of joy becomes large when the team A leads. Thus, the audio pressure of the shout of joy is made the key audio data, and when a specified audio pressure of the shout of joy or higher is not detected, since there is a high possibility that the team A is beaten, the recording of the baseball relay is ended.

(2-5) Method in which a check is performed against key audio data (sound of a game still livening up, ending music, commercial, or sound indicating a corner, such as news or weather forecast, broadcasted at the end of the program) by which the broadcast state of a former program can be confirmed, and the setting of the recording reservation of the reserved program is changed according to the detection result of the key audio data.

For example, when a drama starting at 9 p.m. after a baseball relay is recorded, there is a case where the baseball relay is extended and the start of the drama is extended by 30 minutes. In this case, when the recording is started after the theme music of the ending of the baseball relay streams, the former 30 minutes of the drama is not cut and the whole can be recorded.

The detailed contents of the respective methods will be described later.

Incidentally, when the change of the reservation relates to the change of the reservation time, in the case where the delay time of a program before a scheduled one can be judged, or in the case where delay time information of a corner or the like in a program always broadcasted at the identical time can be judged, the recording scheduled time is changed using the delay time.

(3) Content of Reservation Control Processing

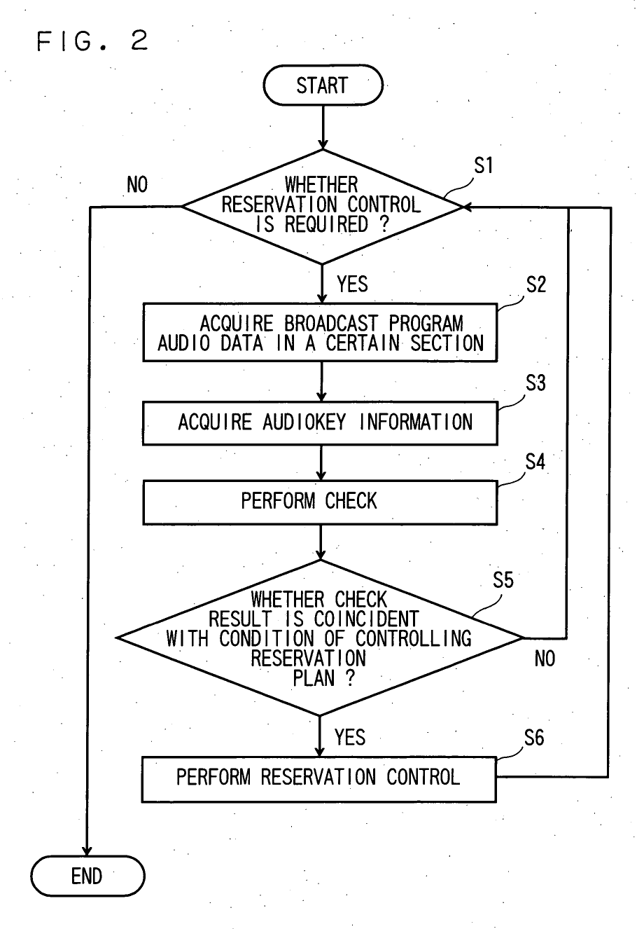

FIG. 2 is a flowchart showing a reservation control processing to a program being recorded.

At step S1, it is confirmed whether the program is being recorded and the reservation control is necessary. In the case where the reservation control is unnecessary, the processing is ended.

In the case where the reservation control is necessary, at step S2, audio data of the program in a certain section is acquired, and further, at step S3, key audio data is acquired.

At step S4, a check is performed based on a previously set condition.

At step S5, it is confirmed whether the check result is coincident with the condition under which the reservation plan is controlled, and when not coincident, the processing is again performed from step S1. In the case where it is coincident with the condition under which the reservation plan is controlled, at step S6, the reservation control is performed, and the processing is again started from step S1.

(4) Modified Example

Incidentally, a structure may be made such that plural programs can be received and recorded at the identical time.

(5) Example of Recording Plan

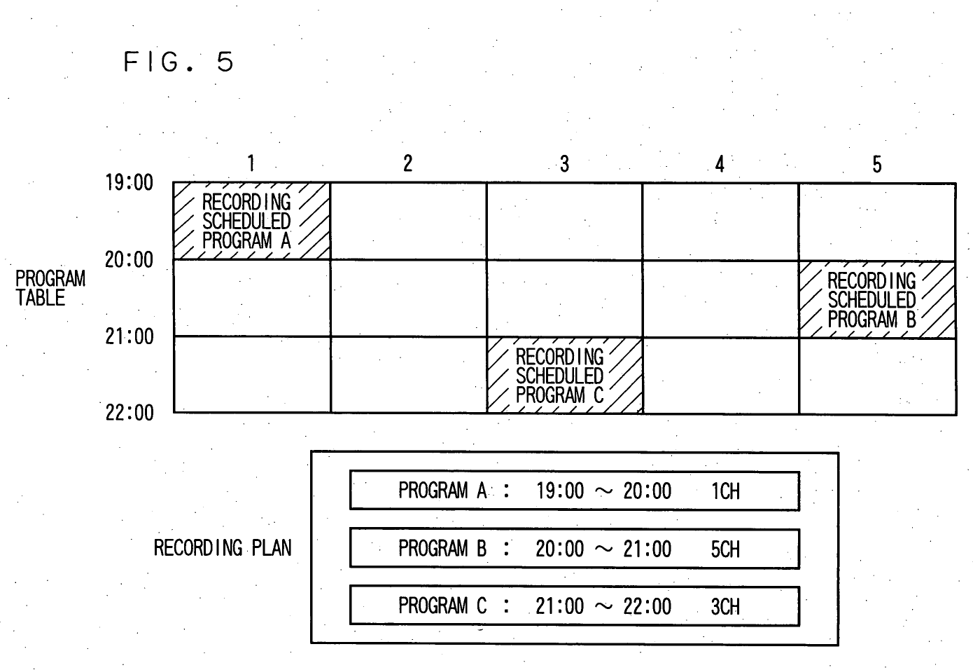

While referring to a program table or the like, the user uses a remote control of the broadcast reception apparatus 10 to input a broadcast station as a recording object, a time when the recording starts, and a time when it ends, and creates a recording plan of a reserved program (see FIG. 5). Based on the recording plan, the reserved program recording apparatus sets the recording broadcast station of the reserved program, the recording start scheduled time, and the recording end time, and performs the recording. In the reserved program recording apparatus capable of referring to an electronic program table, when the user selects the reserved program to be recorded, information necessary for the recording plan is automatically acquired from the information of the electronic program table, so that the recording plan is created.

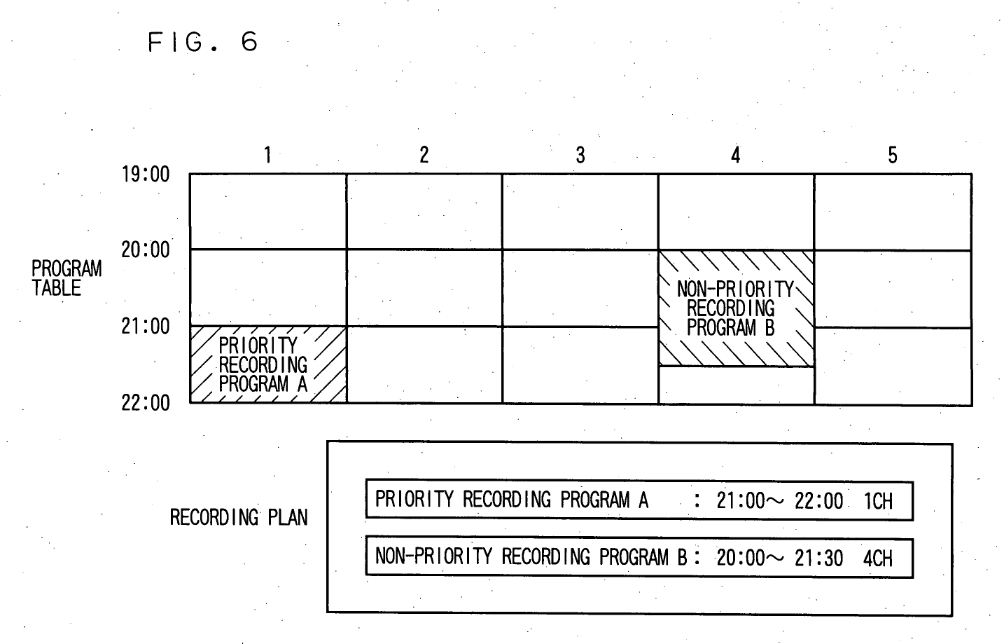

Incidentally, the recording plan can use the recording plan in which priority of recording or a condition is given, or the recording plan in which programs of plural broadcast stations are recorded at the same time (see FIG. 6).

Besides, it is possible to use a recording plan created by a system which selects a program according to the preference of the user.

(6) Processing of Extension of Recording Start Time of Reserved Program

(6-1) Flow of Processing of Extension of Recording Start Time

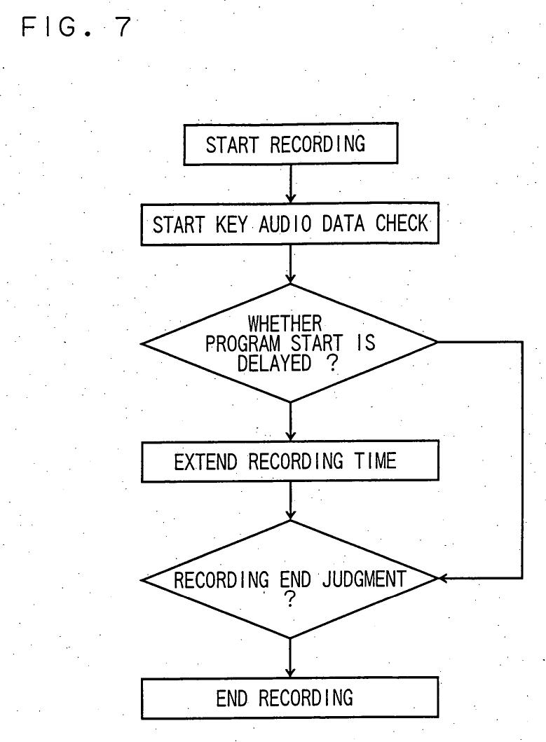

FIG. 7 is a flowchart showing an operation of using the broadcast reception apparatus 10 of the embodiment, estimating a delay time of a start of a reserved program being recorded, and changing a recording end scheduled time by the delay time. Specifically, there is shown a case where a drama from 9 p.m. to 10 p.m. starts at 9:30 p.m. by an extended baseball relay.

Based on the recording plan, when it becomes the recording start scheduled time (9:00 p.m.), the recording starts.

Subsequently, confirmation of the check between the audio of the reserved program being recorded and the key audio data is started.

Based on the check result of the key audio data, it is confirmed whether the program start is delayed. This method will be described later. When the delay is not confirmed, the recording is performed in accordance with the recording plan, and when it becomes the recording end scheduled time (10:00 p.m.), the recording is ended.

In the case where the delay is confirmed, the recording end time of the reserved program is extended by the delay estimated time (30 minutes), and when it becomes the changed recording end time (10:30 p.m.), the recording is ended.

(6-3) First Check Method

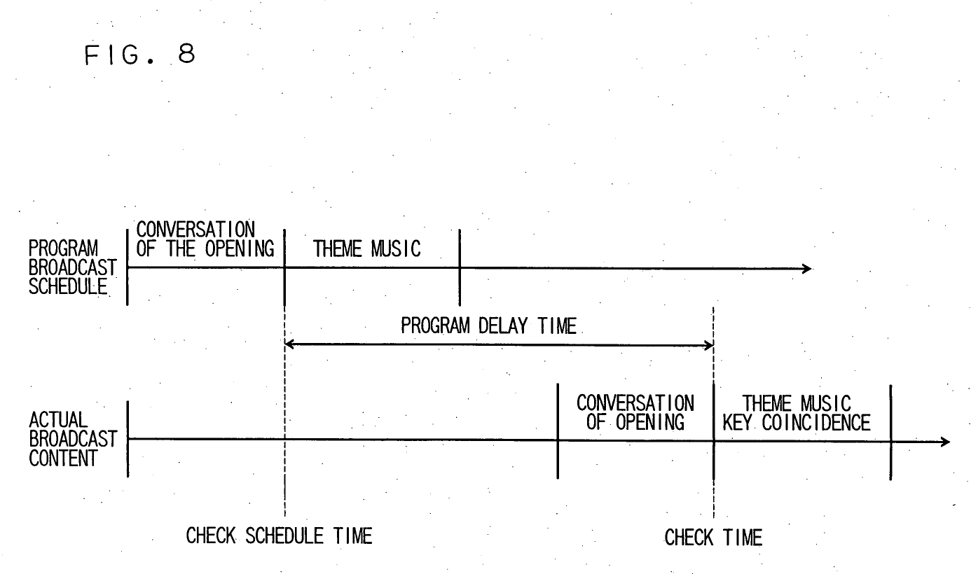

FIG. 8 is a view showing a first method in which audio key check against the reserved program is performed to estimate the program start delay time.

The reserved program shown in FIG. 8 is such that after the beginning conversation portion proceeds for a certain time from the broadcast start time, the theme music of the opening of the drama streams.

The key audio data is the theme music, and the scheduled time of the stream is made the check scheduled time (for example, 9:05 p.m.).

The check of the key audio data is started from the program recording start time (9:00 p.m.), a difference between the actual check time (for example, 9:35 p.m.) and the check scheduled time (9:05 p.m.) is confirmed, and the difference of 30 minutes is estimated as the program delay time.

(6-4) Second Check Method

As the estimation of the delay information, not the check of the key audio data to the reserved program as the object, but the check of the key audio data to the broadcast content before the reserved program delay time is used and the delay time of the broadcast may be estimated.

(7) Processing of Program Reservation with Priority

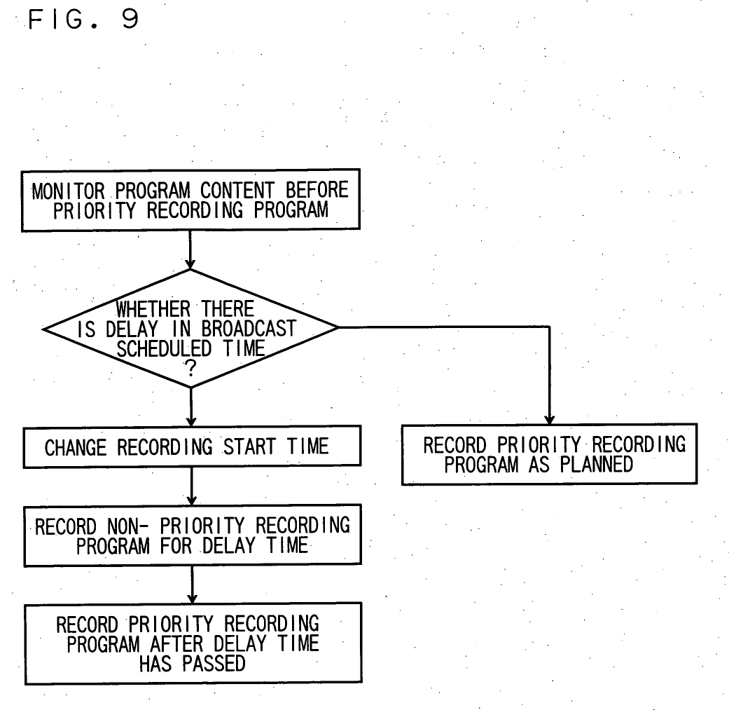

FIG. 9 is flowchart showing an operation of estimating a delay time from a program broadcasted before a reserved program, changing a recording time, and recording another program for a delay estimated time.

Specifically, it is assumed that there are two candidates of the reserved program to be recorded at the identical time, and they are different from each other in priority. In that case, the broadcast content before the reserved program (hereinafter referred to as the priority recording program) whose recording is performed with priority is monitored. In the case where there is no delay in the broadcast start time of the priority recording program, the priority recording program is recorded as scheduled. In the case where it is judged that there is a delay, the recording start time of the priority recording program is changed by the delay estimated time. During the time, a reserved program having no priority (hereinafter referred to as a non-priority recording program) is recorded for the delay estimated time. Then, after the delay estimated time has passed, the recording of the non-priority recording program is ended, and the priority recording program delayed and broadcasted is recorded.

(8) Processing of Extension of Recording End Time of Reserved Program

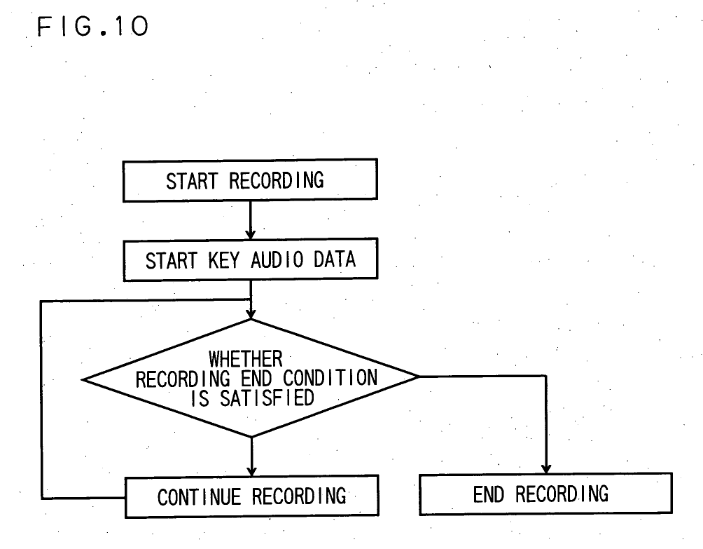

FIG. 10 is a flowchart showing an operation of using a check result of key audio data, judging a recording end condition, and ending the recording.

At the same time as the start of the recording of the reserved program, the key audio data check is performed, and it is judged whether the recording end condition is satisfied based on the result of the check.

The recording of the reserved program, the check of the key audio data, and the program end judgment are continued until it is judged that the end condition is satisfied.

When it is judged that the end condition is satisfied, the recording of the program is ended.

As the recording end condition, a program end judgment can be used. The program end judgment is such that the reserved program is made an object, and when there is coincidence with key audio data (for example, ending theme music) by which the program is judged to be ended, it is judged to be ended.

(8-1) Modified Example 1

Incidentally, after the recording is ended, when the recording plan is changed to perform recording of another program, efficient recording becomes possible.

Besides, it is also possible to perform a check of key audio data while subsequent broadcast content is made an object. In the case where the check of the key audio data relating to the subsequent program is not detected, the recording is continued, and in the case where the check is detected, a judgment is made that the recording object program is ended, and a judgment to end the recording may be made.

As the recording end condition, setting may be made such that when the content desired by the user is confirmed, the recording is ended.

By this setting, for example, such setting that recording is ended when the sport corner of a news program is ended can also be made.

(8-2) Modified Example 2

On the other hand, setting may be made such that in the case where it is judged that the content desired by the user is not contained, the recording is ended.

Besides, with respect to a sport relay program, setting may be made such that the key audio data is made a shout of joy, and in the case where the data of the shout of joy is not detected, it is judged that the game is stopped, and the recording is ended.

(9) Use Method of Key Audio Data Check Result at Time of Viewing

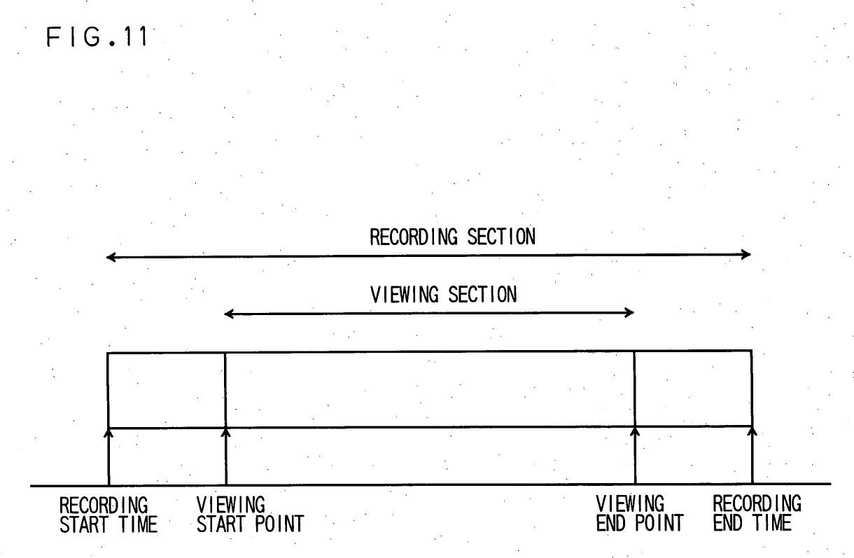

FIG. 11 is a view showing a use method of key audio data check result to a recorded reserved program at time of viewing.

When the key audio data check result to the recorded reserved program, together with the recorded content, is stored, it can be used at the time of viewing of the recorded content.

With respect to a previously scheduled broadcast start time and broadcast end time, a recording setting time is set and recording is performed so that a fail in the recording does not occur, and at the time of viewing, when the key audio data to estimate the opening or the end of the program is used, it becomes possible to view only the range required by the user.

Besides, when the key audio data is not detected, it is judged that the information required by the user is not contained in the program content, and the viewing can be stopped.

(10) Method of Determining Recording Content to External Medium

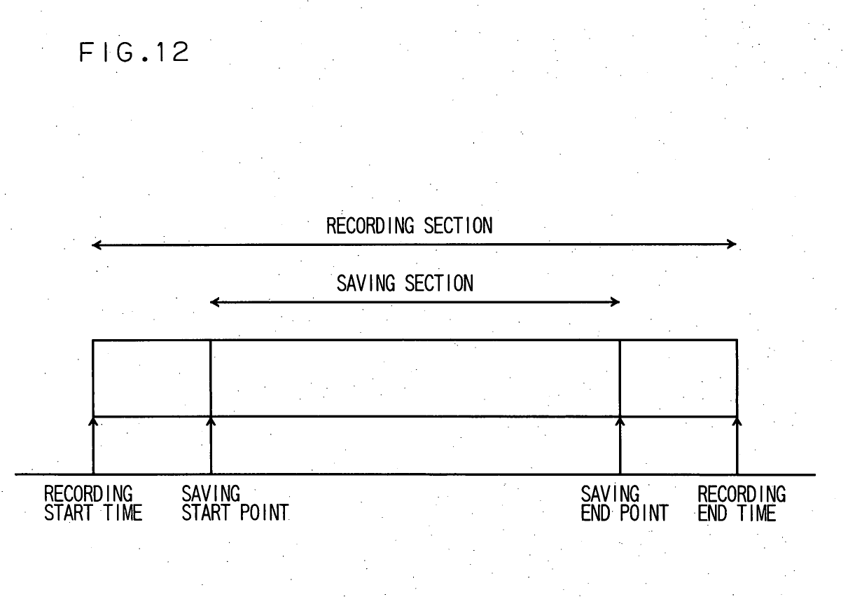

FIG. 12 is a view showing a method in which a key audio data check result to a reserved program is used, and recording content to an external medium is determined.

When the key audio data check result to the recorded reserved program, together with the recording content, is stored, it can be used at the time of recording to the external medium.

In a reserved program recording apparatus which can temporarily store a large amount of data, as typified by a HDD recorder, with respect to a previously scheduled broadcast start time and broadcast end time, a recording setting time is set and recording is performed so that a fail in the recording does not occur, and it becomes possible to record only the required range onto the external storage medium such as a DVD.

Besides, when the key audio data is not detected, it is judged that the information required by the user is not contained in the program content, and it becomes possible to delete the recording information.

### Second Embodiment

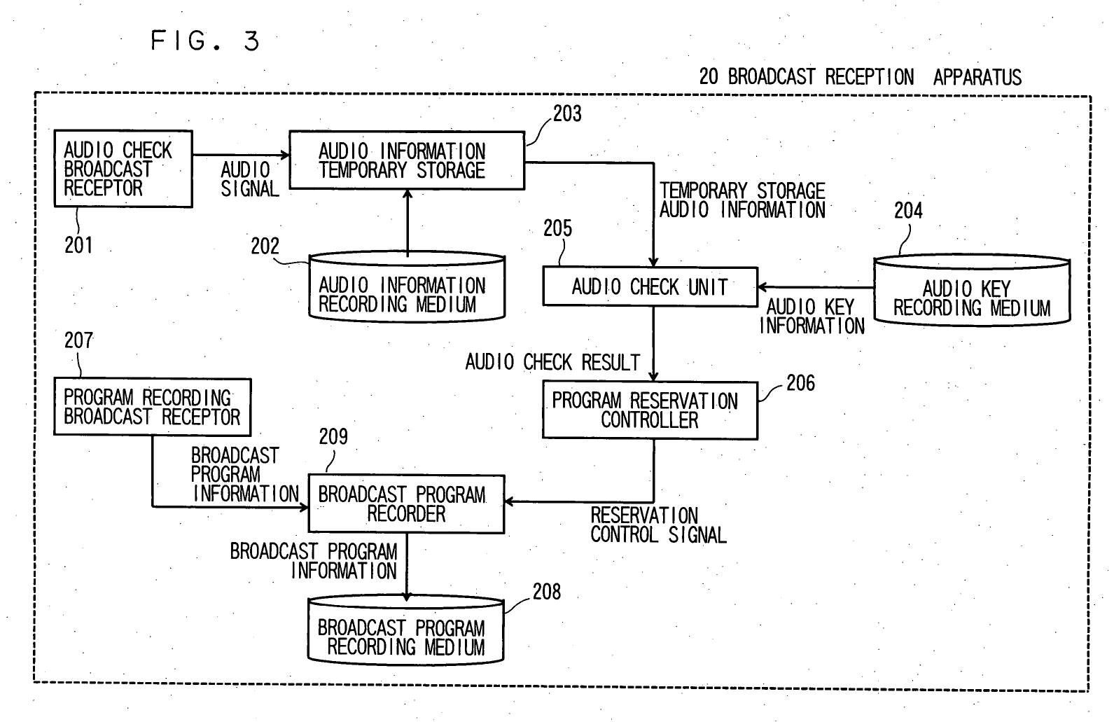

A broadcast reception apparatus 20 of a second embodiment in which a reserved program recording apparatus of the invention is applied will be described with reference to FIG. 3.

FIG. 3 is a block diagram showing a broadcast reception apparatus 20 of this embodiment.

A different point between this embodiment and the first embodiment is that an audio check broadcast reception part 201 to receive a broadcast program for audio checking and a program recording broadcast reception part 207 to receive a broadcast program for program recording are separate bodies.

This embodiment is carried out as, for example, a product, such as a video recorder or a HDD recorder, which receives and records television broadcast.

As shown in FIG. 3, the broadcast reception apparatus 20 includes an audio check broadcast reception part 201 to receive a broadcast program for audio checking, an audio information temporary storage part 203 to acquire audio information from an audio signal and to record it onto an audio information recording medium 202, an audio check part 205 to check audio key information recorded on an audio key recording medium 204 against the temporarily stored audio information, a program reservation control part 206 to determine a program reservation control method based on an audio check result, a program recording broadcast reception part 207 to receive a broadcast program for program recording, and a broadcast program recording part 209 to record the broadcast program onto a broadcast program recording medium 208.

The audio check broadcast reception part 201 separates and acquires program audio data for checking, and supplies it to the audio information temporary storage part 203. The program audio data for checking is not necessarily contained in the same program as the broadcast program for program recording.

The audio information temporary storage part 203 temporarily records the acquired program audio data for checking onto the audio information temporary recording medium 202, and supplies it to the audio check part 205 based on an instruction from the audio check part 205. The audio information temporary recording medium 202 is constructed of, for example, an IC memory or the like.

The audio check part 205 acquires the program audio for checking in a certain section from the audio information temporary storage part 203, acquires the key audio data from the key audio data storage medium 204, and performs a check. The check is performed based on a previously determined specified condition, such as a method of detecting only completely the same things or detection of existence of places similar to each other in audio feature amount, and the check result is supplied to the program reservation control part 206.

The program reservation control part 206 refers to the audio check result, determines a reservation control method, and supplies a program reservation control signal to the broadcast program recording part 209 based on the reservation control method. For example, it supplies a program reservation control signal to change a program to be recorded when content produced at irregular intervals starts in another program broadcasted at the identical time as the program being recorded.

The broadcast program recording part 209 acquires broadcast program information based on a previously set recording plan, and records it onto the broadcast program recording medium 208. The broadcast program recording medium 208 is constructed of, for example, an optical disk, a HDD (magnetic disk), a magnetic tape or the like. The broadcast program recording part 209 acquires the program reservation control signal, and can change the recording plan. As the control of the reservation, it is possible to perform the extension of the reserved time, the stop of the reservation, the change of the recorded program, or the like.

Incidentally, a structure may be made such that plural programs are received at the identical time and can be recorded, or a structure may be made such that plural programs used for checking are received, and the program reservation control can be performed based on the check result.

### Third Embodiment

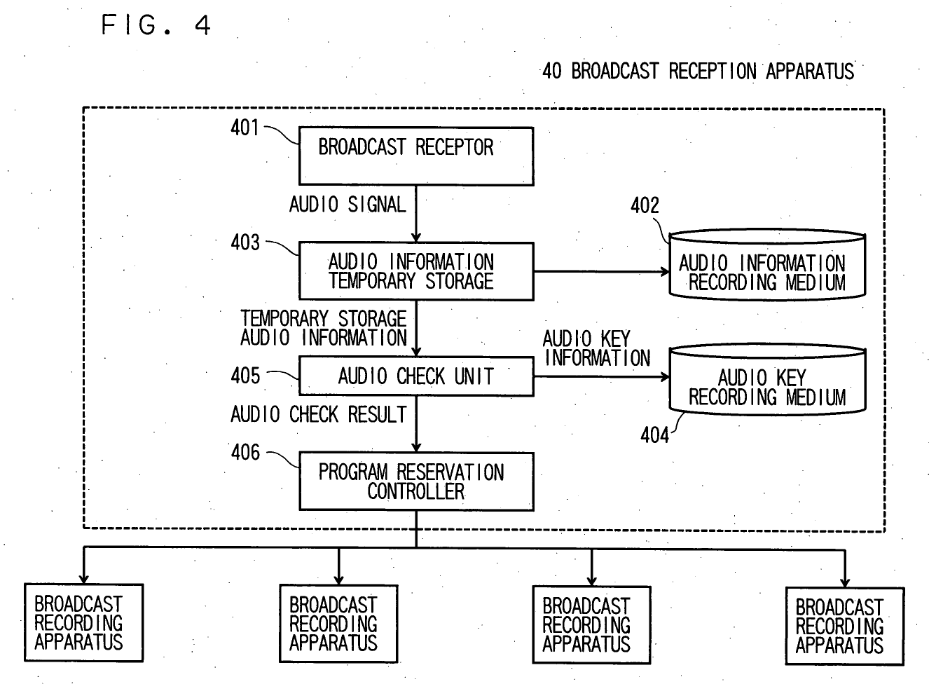

A broadcast reception apparatus 40 of a third embodiment of the invention will be described with reference to FIG. 4.

FIG. 4 is a block diagram showing the broadcast reception apparatus 40 of this embodiment.

This embodiment is carried out as a product such as a home server to manage plural equipments.

As shown in FIG. 4, the broadcast reception apparatus 40 includes an audio check broadcast reception part 401 to receive a broadcast program for audio checking, an audio information temporary storage part 403 to acquire audio information from an audio signal and to record it onto an audio information recording medium 402, an audio check part 405 to check audio key information recorded on an audio key recording medium 404 against the temporarily stored audio information, and a program reservation control part 406 to determine a program reservation control method based on an audio check result.

The audio check broadcast reception part 401 separates and acquires program audio data for checking, and supplies it to the audio information temporary storage part 403.

The audio information temporary storage part 403 temporarily records the acquired program audio data for checking onto the audio information temporary recording medium 402, and supplies it to the audio check part 405 based on an instruction from the audio check part 405. The audio information temporary recording medium 402 is constructed of, for example, an IC memory or the like.

The audio check part 405 acquires program audio for checking in a certain section from the audio information temporary storage part 403, acquires key audio data from the key audio data recording medium 404, and performs a check. The check is performed based on a previously determined specified condition, such as a method of detecting only completely the same things or detection of existence of places similar to each other in audio feature amount, and the check result is supplied to the program reservation control part 406.

The program reservation control part 406 refers to the audio check result, determines the reservation control method, and supplies a program reservation control signal to the broadcast recording apparatus based on the reservation control method.

A structure may be made such that the program reservation control signal from the broadcast reception apparatus 40 to the broadcast recording apparatus is sent through a network such as a LAN or is sent as a remote control signal.

Besides, in the case where the program reservation control signal can be supplied to plural broadcast recording apparatuses, the control may be made such that the program reservation plans of the respective broadcast recording apparatuses are confirmed, and it is sent to the optimum equipment.

Incidentally, the program audio data for checking may be constructed such that plural programs are received at the identical time, and the check can be performed.

(Modified Example)

The invention is not limited to the respective embodiments, but can be variously modified within the scope of its gist.

For example, in the embodiment, although the description has been given of the apparatus which receives the program from the broadcast signal and records it, the invention is not limited to this, and the apparatus may record a program delivered via the Internet. Besides, the invention may be applied not only to an apparatus to record video and audio information typified by television broadcast, but also to a recording apparatus to record only audio, such as in radio broadcast.

What is claimed is:

1. A reserved program recording apparatus for performing picture recording or audio recording of a broadcasted or delivered program, as a reserved program, onto a recording medium based on a previously set recording plan including a reservation start time or a reservation end time, comprising:
a program data acquisition processor unit configured to acquire program data of the broadcasted or delivered program;
an audio data acquisition processor unit configured to acquire audio data of the broadcasted or delivered program;
a key audio data acquisition processor unit configured to read key audio data used for confirmation of content of the broadcasted or delivered program from the recording medium;
a key audio data check processor unit configured to check the key audio data against the audio data and to acquire check result information; and
a program reservation change processor unit configured to change the recording plan based on the check result information.

2. The reserved program recording apparatus according to claim 1, wherein the key audio check processor unit acquires the check result information when the recorded key audio data is coincident with the inputted audio data of the program.

3. The reserved program recording apparatus according to claim 1, wherein the key audio check processor unit outputs the check result information when the recorded key audio data is not coincident with the inputted audio data of the program within a time stipulated in the recording plan.

4. The reserved program recording apparatus according to claim 1, wherein the program reservation change processor unit changes the reservation start time or the reservation end time in the recording plan based on the check result.

5. The reserved program recording apparatus according to claim 1, wherein the program reservation change processor unit stops recording of the reserved program based on the check result.

6. The reserved program recording apparatus according to claim 1, wherein the program reservation change processor unit erases recording of the reserved program from the recording medium based on the check result.

7. The reserved program recording apparatus according to claim 1, wherein the program reservation change processor unit notifies a user of a change in the recording plan.

8. The reserved program recording apparatus according to claim 1, wherein the key audio data relates to audio data of a program to be broadcasted or delivered after the reserved program.

9. The reserved program recording apparatus according to claim 1, wherein the key audio data relates to audio data of a program to be broadcasted or delivered before the reserved program.

10. The reserved program recording apparatus according to claim 1, wherein the key audio data relates to audio data of a program to be broadcasted or delivered at an identical time to the reserved program.

11. A reserved program recording apparatus for performing picture recording or audio recording of a broadcasted or delivered program, as a reserved program, onto a recording medium based on a previously set recording plan including a reservation start time or a reservation end time, comprising:
a program data acquisition processor unit configured to acquire program data of the broadcasted or delivered program;
an audio data acquisition processor unit configured to acquire audio data of the broadcasted or delivered program;
a key audio data acquisition processor unit configured to read key audio data used for confirmation of content of the broadcasted or delivered program from the recording medium;
a key audio data check processor unit configured to check the key audio data against the audio data of the program and to acquire check result information; and
a viewing position determination processor unit configured to determine a viewing start position on the recorded reserved program or a viewing end position based on the check result information.

12. A reserved program recording method for performing picture recording or audio recording of a broadcasted or delivered program, as a reserved program, onto a recording medium based on a previously set recording plan including a reservation start time or a reservation end time, comprising:
acquiring program data of the broadcasted or delivered program;
acquiring audio data of the broadcasted or delivered program data;
recording key audio data as a retrieval key for picture recording or audio recording of the reserved program;
checking the recorded key audio data against the acquired audio data of the program to acquire check result information; and
changing the recording plan based on the check result information.

13. A reserved program recording method for performing picture recording or audio recording of a broadcasted or delivered program, as a reserved program, onto a recording medium based on a previously set recording plan including a reservation start time or a reservation end time, comprising:
acquiring program data of the broadcasted or delivered program;
acquiring audio data of the broadcasted or delivered program data;
recording key audio data as a retrieval key for picture recording or audio recording of the reserved program;
checking the recorded key audio data against the acquired audio data of the program to acquire check result information; and
determining a viewing start position of the recorded reserved program or a viewing end position based on the check result information.

14. A reserved program recording program product for causing a computer to realize a reserved program recording method of performing picture recording or audio recording of a broadcasted or delivered program, as a reserved program, onto a recording medium based on a previously set recording plan including a reservation start time or a reservation end time, the program product comprising instructions of:
program data inputting function acquiring program data of the broadcasted or delivered program;
audio data inputting function acquiring audio data of the broadcasted or delivered program data;
key audio data recording function recording key audio data as a retrieval key for picture recording or audio recording of the reserved program;
checking the recorded key audio data against the acquired key audio checking function audio data of the program to acquire check result information; and
reserved program changing function changing the recording plan based on the check result information.

15. A reserved program recording program product for causing a computer to realize a reserved program recording method of performing picture recording or audio recording of a broadcasted or delivered program, as a reserved program, onto a recording medium based on a previously set recording plan including a reservation start time or a reservation end time, the program product comprising instructions of:
program data inputting function acquiring program data of the broadcasted or delivered program;
audio data inputting function acquiring audio data of the broadcasted or delivered program data;
key audio data recording function recording key audio data as a retrieval key for picture recording or audio recording of the reserved program;
key audio checking function checking the recorded key audio data against the acquired audio data of the program to acquire check result information; and
viewing time determining function determining a viewing start time of the recorded reserved program or a viewing end time based on the check result information.
